(19) United States
(12) Patent Application Publication
(10) Pub. No.: US 2008/0245564 A1
(43) Pub. Date: Oct. 9, 2008

(54) POWER FEEDING BOX

(75) Inventor: Kaoru SUZUKI, Kosai-shi (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 12/058,837

(22) Filed: Mar. 31, 2008

(30) Foreign Application Priority Data
Mar. 29, 2007 (JP) 2007-088275

(51) Int. Cl. H01R 13/46

(52) U.S. Cl. 174/520

(57) ABSTRACT

A power feeding box includes an electric wire for feeding a power to a movable body to be moved in up-and-down directions and a housing unit contains a surplus length of the electric wire. The housing unit includes an inlet port which is provided on an upper side of the housing unit for introducing the electric wire into the housing unit, an opening portion which is provided on a side face of the housing unit along in the up-and-down directions, and a movable unit which fixes the electric wire extracted from the opening portion so as to move the electric wire in the up-and-down directions together with the movable unit. The housing unit is provided in a lower half of a movable range of the movable unit.

### BACKGROUND

The present invention relates to a power feeding box and, more particularly, to a power feeding box including an electric wire for feeding a power to a movable body to be moved in up-and-down directions, and a box-shaped housing unit for containing the surplus length of the electric wire.

A windshield glass mounted in a vehicle for moving in up-and-down directions is exemplified by using a dimmer glass or by attaching a heater wire to the windshield glass. In the case of this windshield glass, the windshield glass has to be energized by using a power line. This power line is given a sufficiently excess length for feeding the power source even when the windshield glass rises and falls. In Patent Document 1, there is proposed an excess electric wire length absorbing device, which can accommodate the excess length of the electric wire L so that the excess length may not be caught by a peripheral device.

The aforementioned excess electric wire length absorbing device includes a case (i.e., a housing unit) for housing the excess length of the electric wire elongated in up-and-down directions, a sliding unit having the electric wire connected therewith for moving along that case, a stationary unit disposed on the face on the side opposite to the sliding unit, a loop-shaped flat cable housed in the case for connecting the sliding unit and the stationary unit. Moreover, a ring-shaped flat cable is housed movably along that case.

In the aforementioned electric wire excess length absorbing device of the prior art, however, the sliding unit moves along the case. Moreover, the aforementioned flat cable is exemplified by using such a high rigid one as warps to the upper side against its own weight. This use raises a problem that the case has to be disposed on the upper side of the stationary portion so that the case is large-sized.

### [Patent Document 1] JP-A-2005-57828

### SUMMARY

Noting the aforementioned problems, therefore, the present invention has an object to provide a power feeding box, which is intended to reduce the size of a housing unit for housing the excess length of an electric wire.

In order to achieve the above object, according to the present invention, there is provided a power feeding box, comprising:

an electric wire for feeding a power to a movable body to be moved in up-and-down directions; and

a housing unit contains a surplus length of the electric wire,

wherein the housing unit includes:
an inlet port which is provided on an upper side of the housing unit for introducing the electric wire into the housing unit;
an opening portion which is provided on a side face of the housing unit along in the up-and-down directions; and
a movable unit which movably fixes the electric wire extracted from the opening portion so as to move the electric wire in the up-and-down directions together with the movable unit; and

wherein the housing unit is provided in a lower half of a movable range of the movable unit.

According to the above configuration, the housing unit is disposed at the lower half of the movable range of the movable unit, and the inlet port of the electric wire is formed in the upper face of the housing unit. With one end of the electric wire being fixed in the inlet port formed at the center of the movable range of the movable unit, therefore, the other end of the electric wire is moved to the side of the lower half by the rise and fall of the movable unit. Without making the electric wire rigid, moreover, the electric wire is always warped to the lower side by its own weight. As a result, the warped portion of the electric wire occurs on the side lower than the inlet port, so that the housing unit can be disposed in the lower half of the movable range of the movable unit. Therefore, the size of the housing unit in the up-and-down directions can be made half of the movable range.

Preferably, a side face of the housing unit in a vicinity of the inlet port is extended toward a lower end portion of the housing unit so as to gradually leave from the inlet port.

According to the above configuration, the lower end portion of the side face of the housing unit on the side of the inlet port has the tapered portion to leave the more as its goes the farther downward. Therefore, the size of the lower side of the housing unit can be made the smaller.

Preferably, the opening portion is separated from the inlet port in a first orthogonal direction perpendicular to the up-and-down directions.

According to the above configuration, the opening portion and the inlet port are disposed in the housing unit on the first side face and spaced in the first orthogonal direction perpendicular to the up-and-down directions. Therefore, the inlet port and the opening portion can be spaced as long as possible so that the warping diameter of the electric wire can be enlarged to make effective use of the inside of the housing unit.

Preferably, the opening portion is separated from the inlet port in a second orthogonal direction perpendicular to the first orthogonal direction and the up-and-down directions.

According to the above configuration, the opening portion and the inlet port are disposed in the housing unit on the second side face perpendicular to the first side face and spaced in the second orthogonal direction perpendicular to the up-and-down directions and the first orthogonal direction. As a result, the opening and the inlet port can be spaced as far as possible so that the warping diameter of the electric wire can be enlarged to make effective use of the inside of the housing unit.

Preferably, the power feeding box further comprises a pair of guide rail portions which guide a movement of the movable unit. The guide rail portions are integrally formed with the housing unit so as to interpose the opening portion therebetween.

According to the above configuration, the guide rail portions are so integrated with the housing unit as to interposed the opening portion of the housing unit. Therefore, the excess length of the electric wire is so contained by the guide rail portions, even if the movable unit is positioned on the upper side of the housing unit.

Preferably, the power feeding box further comprises a tension cable which is provided between the movable unit and the movable body. The tension cable is shorter in a length than the electric wire arranged between the movable unit and the movable unit.

According to the above configuration, the tension cable is interposed between the movable unit and the movable body, so that the force from the movable body is always transmitted through the tension cable to the movable unit. Therefore, no tension can be applied to the electric wire.

According to the above configuration, the size of the housing unit in the up-and-down directions can be made half of the movable range so that it can be reduced.

According to the above configuration, the size of the lower size of the housing unit can be made half of the movable range so that the housing unit can be further reduced.

According to the above configuration, the inlet port and the opening can be spaced as long as possible so that the warping diameter of the electric wire can be enlarged to make effective use of the inside of the housing unit. As a result, the housing unit can be further reduced.

According to the above configuration, the excess length of the electric wire is so contained by the guide rail portions, even if the movable unit is positioned on the upper side of the housing unit. Even if the housing unit is made small, therefore, the electric wire is not exposed to the outside from the power feeding box.

According to the above configuration, the force from the movable body is always transmitted through the tension cable to the movable unit so no tension can be applied to the electric wire. Therefore, it is possible to prevent a breakage such as a disconnection of the electric wire.

### BRIEF DESCRIPTION OF THE DRAWINGS

The above objects and advantages of the present invention will become more apparent by describing in detail preferred exemplary embodiments thereof with reference to the accompanying drawings, wherein:

FIGS. 1A and 1B are views showing a vehicular door, on which the power feeding box of the invention is mounted;

FIG. 2 is a perspective view of the power feeding box, as taken from the inside of a vehicle compartment;

FIG. 3 is a perspective view of the power feeding box, as taken from the outside of the vehicle compartment;

FIG. 4 is a section of the power feeding box shown in FIG. 3 and taken along line V-V:

FIGS. 5A to 5C are sections of the power feeding box shown in FIG. 3 and taken along line VI-VI;

FIG. 6 is a section along line VII-VII of FIG. 4; and

FIG. 7 a section along line VII-VII of FIG. 4 in another embodiment.

### DETAILED DESCRIPTION OF EXEMPLARY EMBODIMENTS

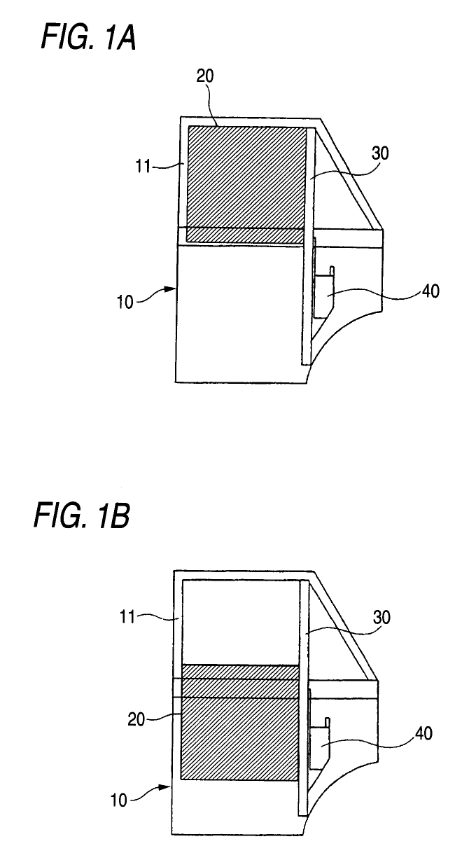

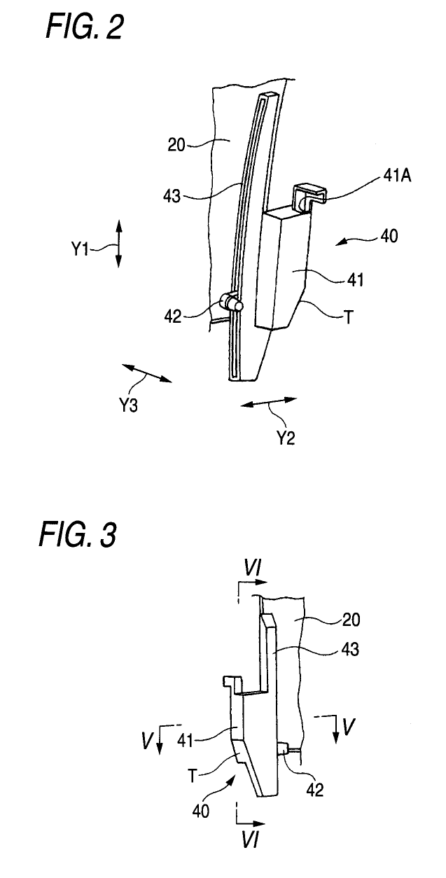

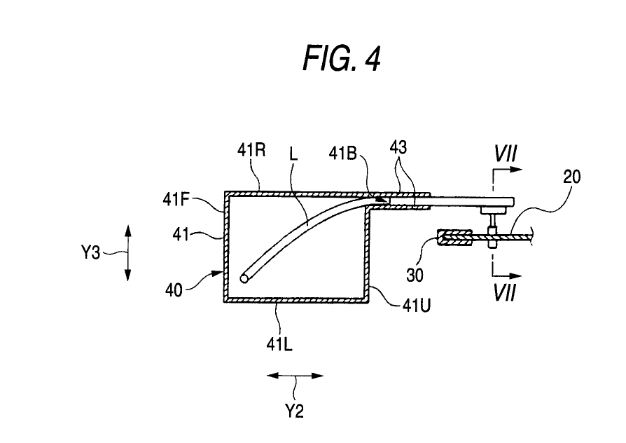

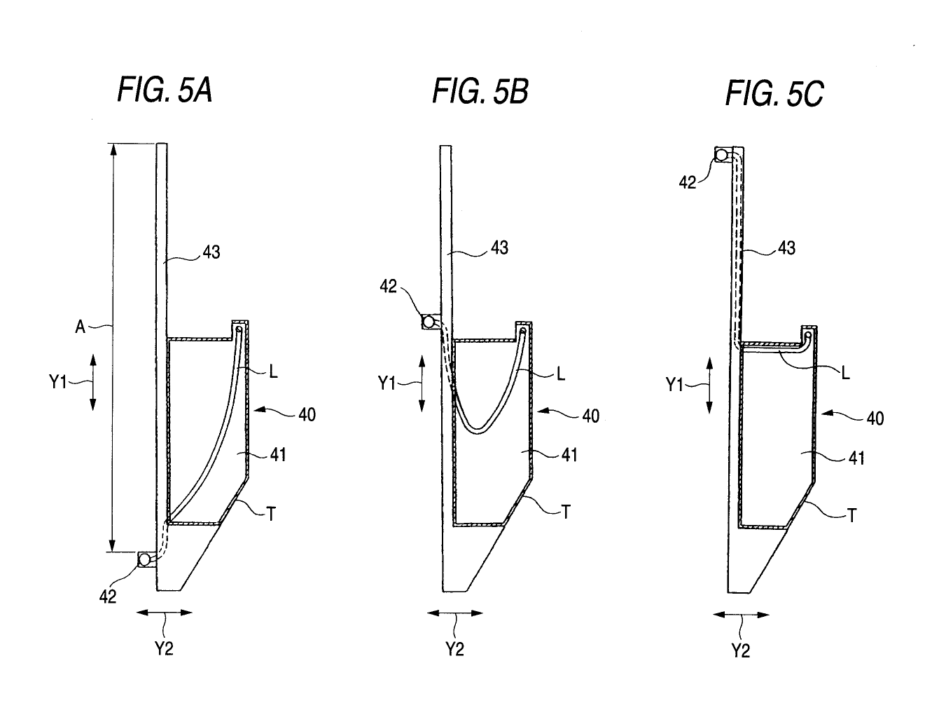

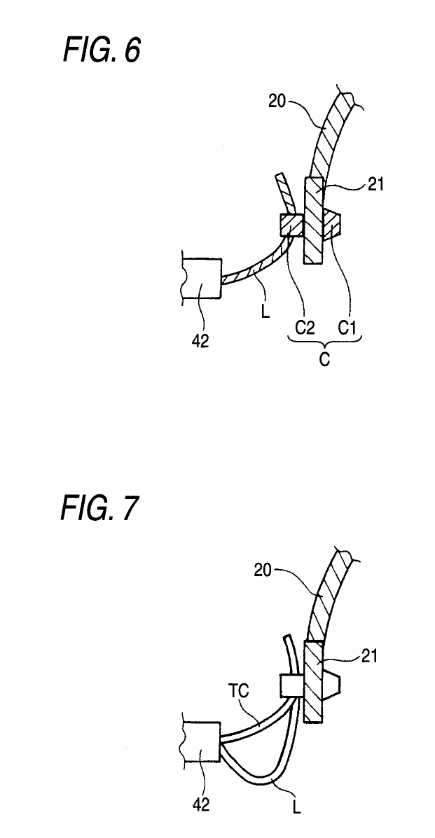

In the following, a power feeding box of the present invention is described with reference to the accompanying drawings. FIGS. 1A and 1B are views showing a vehicular door, on which the power feeding box of the invention is mounted. Here, FIG. 1A is a view showing a vehicular door when a movable glass is closed, and FIG. 1B is a view showing the vehicular door when the movable glass is opened. FIG. 2 is a perspective view of the power feeding box, as taken from the inside of a vehicle compartment. FIG. 3 is a perspective view of the power feeding box, as taken from the outside of the vehicle compartment. FIG. 4 is a section of the power feeding box shown in FIG. 3 and taken along line V-V. FIGS. 5A and B are sections of the power feeding box shown in FIG. 3 and taken along line VI-VI. Here: FIG. 5A is a section when the movable glass is closed; FIG. 5B is a section when the movable glass shifts from the closed state to the open state; and FIG. 5C is a section when the movable glass is opened. FIG. 6 is a section along line VII-VII of FIG. 4.

As shown in FIGS. 1A and 1B, the vehicular door includes a door outer panel 10, a not-shown door inner panel, a movable glass 20, a glass guide rail 30, and the power feeding box made of a resin or metal. The door outer panel 10 is disposed on the outer side of the vehicle. The door outer panel 10 is equipped with a windshield frame 11. The not-shown door inner panel is disposed on the compartment side of the vehicle. In the space formed between those door outer panel 10 and door inner panel, there are housed the movable glass 20 in the open state, the lower side of the glass guide rail 30, a not-shown motor for driving the movable glass 20, and the power feeding box 40.

The movable glass 20 has a curved face curved in up-and-down directions Y1. The glass guide rail 30 is equipped with a groove curved in the up-and-down directions Y1 along the curved face of the movable glass 20. The edge portion of the movable glass 20 is fitted in that groove. By this groove, moreover, the movable glass 20 is so guided along the curved face as to rise and fall in the up-and-down directions Y1.

In the power feeding box 40, there is housed an electric wire L (FIG. 4 and FIGS. 5A to 5C) for feeding a power source to the aforementioned movable glass 20. As shown in FIG. 2 to FIGS. 5C, the power feeding box 40 includes a box-shaped housing unit 41, a movable unit 42 and a pair of guide rail portions 43. The housing unit 41 is formed generally into a box shape. The aforementioned housing unit 41 is equipped with an inlet port 41A (FIG. 2) and an opening 41B (FIG. 4).

The inlet port 41A is an opening formed in the housing unit 41 for introducing the electric wire L into the housing unit 41. As shown in FIG. 3, the inlet port 41A is formed in the upper face of the housing unit 41 at the end portion of the side apart from the movable glass 20 in fore-and-aft directions Y2. As shown in FIG. 4, the fore-and-aft directions Y2 intersect at right angles with the up-and-down directions Y1 on side faces 41R and 41L (a first side face), and correspond to the first orthogonal directions. The inlet port 41A is formed in the end portion of the upper face of the housing unit 41 on the side of the (one) door inner panel in side-to-side directions Y3. Here, the side-to-side directions Y3 are perpendicular to the up-and-down directions Y1 on side faces 41F and 41U (or a second side face) perpendicular to the aforementioned side faces 41R and 41L, and correspond to the second orthogonal direction. As shown in FIG. 4, on the other hand, the opening 41B is formed in the side face of the housing unit 41 in the side face on the side of the movable glass 20 in the fore-and-aft directions Y2. The opening 41B is formed in the end portion of the aforementioned side face on the side of the (other) door outer panel 10 in the side-to-side directions Y3.

The movable unit 42 moves up and down in the up-and-down directions Y1 together with the movable glass 20, to which the electric wire L extracted from the opening 41B is attached. The paired guide rail portions 43 are so disposed along the up-and-down directions Y1 as to guide the rise and fall of the movable unit 42. The paired guide rail portions 43 are so integrated with the housing unit 41 as to interpose the opening 41B of the housing unit 41. As shown in FIGS. 5A to 5C, the housing unit 41 is disposed at the lower half of the movable range A of the movable unit 42.

How to mount the aforementioned movable unit 42 and movable glass 20 is described in the following. As shown in FIG. 6, a bracket 21 having a threaded hole is attached to the lower end of the movable glass 20. A clamp C is attached to that bracket 21. The clamp C is constituted of a screw portion C1 and a threaded hole portion C2. In the state where the bracket 21 is clamped between the screw portion C1 and the threaded hole portion C2, moreover, the screw portion C1 is inserted into the bracket 21 and the threaded hole of the threaded hole portion C2 and is fastened to mount the clamp C on the bracket 21. The electric wire L extracted from the movable unit 42 is mounted in the threaded hole portion C2 of that clamp C. The electric wire L extracted from the clamp C is connected with the not-shown dimmer circuit mounted on the movable glass 20.

Next, the length of the electric wire L to be housed in the aforementioned housing unit 41 is described in the following with reference to FIGS. 5A to 5C. As shown in FIG. 5A, the electric wire L is made so short as may not be warped in a letter U when the movable unit 42 is positioned on the lowermost side of the movable range A. Specifically, the electric wire L is made so long as is always directed downward as it approaches the movable unit 42 when the movable unit 42 is positioned on the lowermost side of the movable range A. As a result, a tapered portion T to leave the inlet port 41A the more as its goes the farther downward is formed at the lower end portion of the side face 41F of the housing unit 41 on the side of the inlet port 41A, so that the size of the housing unit 41 can be reduced.

Next, the shape of the electric wire L to be housed in the housing unit 41 when the aforementioned movable unit 42 moves is described in the following with reference to FIGS. 5A to 5C. In the state where the movable unit 42 is positioned in the most downward position of the movable range A, as shown in FIGS. 5A to 5C, the electric wire L is not warped into a U-letter shape but shaped always downward as it becomes closer to the movable unit 42. Next, when the movable unit 42 moves upward, the electric wire L warps downward into the U-letter shape, as shown in FIG. 5B. When the movable unit 42 further moves upward to reach the uppermost position in the movable range A, the electric wire L is shaped along both the ceiling face of the housing unit 41 and the guide rail portions 43, as shown in FIG. 5C.

According to the aforementioned power feeding box 40, the housing unit 41 is disposed at the lower half of the movable range A of the movable unit 42, and the inlet port 41A of the electric wire L is formed in the upper face of the housing unit 41. With one end of the electric wire L being fixed in the inlet port 41A formed at the center of the movable range A of the movable unit 42, therefore, the other end of the electric wire L is moved to the side of the lower half by the rise and fall of the movable unit 42. Without making the electric wire L rigid, moreover, the electric wire L is always warped to the lower side by its own weight. As a result, the warped portion of the electric wire L occurs on the side lower than the inlet port 41A, so that the housing unit 41 can be disposed in the lower half of the movable range A of the movable unit 42. Therefore, the size of the lower side of the housing unit 41 can be made half of the movable range A so that the housing unit can be further reduced.

According to the aforementioned power feeding box 40, moreover, the lower end portion of the side face 41F of the housing unit 41 on the side of the inlet port 41A has the tapered portion T to leave the more as its goes the farther downward. Therefore, the size of the lower side of the housing unit 41 can be made the smaller so that the housing unit 41 can be the more small-sized.

According to the aforementioned power feeding box 40, moreover, the opening 41B and the inlet port 41A are spaced in the fore-and-aft directions Y2. Therefore, the inlet port 41A and the opening 41B can be spaced as long as possible so that the warping diameter of the electric wire L can be enlarged to make effective use of the inside of the housing unit 41.

According to the aforementioned power feeding box 40, moreover, the opening 41B and the inlet port 41A are spaced in the side-to-side directions Y3, too. Therefore, the warping diameter of the electric wire L can be enlarged to make effective use of the inside of the housing unit 41.

According to the aforementioned power feeding box 40, moreover, the paired guide rail portions 43 are so integrated with the housing unit 41 as to interpose the opening 41B of the housing unit 4 inbetween. As shown in FIGS. 6B and 6C, therefore, the excess length of the electric wire L is so housed as is clamped by the paired guide rail portions 43, even if the movable unit 42 is positioned on the upper side of the housing unit 41. Even if the housing unit 41 is made small, therefore, the electric wire L is not exposed to the outside from the power feeding box 40.

Here in the embodiment, as shown in FIG. 6, the movable unit 42 and the movable glass 20 are attached through the electric wire L. With this attachment, however, the force from the movable glass 20 is transmitted to the movable unit 42 through the electric wire L, so that the electric wire L is pulled and broken. As shown in FIG. 7, therefore, a tension cable TC shorter than the electric wire L between the movable unit 42 and the movable glass 20 may be mounted between the movable unit 42 and the movable glass 20. With the tension cable TC being thus mounted, the force from the movable glass 20 through the tension cable TC to the movable unit 42. Therefore, the electric wire L is always kept in a warped state but is not tensed so that it can be prevented from any breakage.

On the other hand, moreover, the aforementioned embodiment has been described on the case, in which the movable glass 20 is used as a movable body, but the invention should not be limited thereto. The movable body may rise and fall in the up-and-down directions Y1.

In the aforementioned embodiment, moreover, the inlet port 41A is formed in the upper face of the housing unit 41, but the invention should not be limited thereto. The inlet port 41A may be formed on the upper side of the housing unit 41, or at the upper end of the side face of the housing unit 41, for example.

In the aforementioned embodiment, moreover, the opening 41B is formed in the side face of the housing unit 41 on the side of the movable glass 20 in the fore-and-aft directions Y2, but the invention should not be limited thereto. The opening 41B may be formed in the side face of the housing unit 41, or in the side face on the side apart from the movable glass 20 in the fore-and-aft directions Y2, in the side of the housing unit 41 on the side of the door outer panel 10 in the side-to-side directions Y3, or in the side face of the side of the door inner panel in the side-to-side directions Y3, for example. However, it is optimum that the opening 41B is formed in the side face close to the movable glass 20, as in the aforementioned embodiment.

Moreover, the aforementioned embodiment has been described with the assumptions that the side faces 41R and 41L belong to the first side face, that the fore-and-aft directions Y2 belong to the first orthogonal directions, that the side faces 41F and 41U belong to the second side face, and that the side-to-side directions Y3 belong to the second orthogonal directions. However, it may also assume that the side faces 41R and 41L belong to the second side face, that the fore-and-aft directions Y2 belong to the second orthogonal directions, that the side faces 41F and 41U belong to the side face, and that the side-to-side directions Y3 belong to the first orthogonal directions. In the aforementioned embodiment, more specifically: the opening 41B in the housing unit 41 is formed in the side of the movable glass 20 in the fore-and-aft directions Y2; the inlet port 41A is formed in the side apart from the movable glass 20 in the fore-and-aft directions Y2 whereas the opening 41B is formed in the side of the door outer panel 10 in the side-to-side directions Y3; the inlet port 41A is formed in the side of the door inner panel in the side-to-side directions Y3; and the opening 41B and the inlet port 41A are spaced not only in the fore-and-aft directions Y2 but also in the side-to-side directions Y3. However, the invention should not be limited thereto. For example, the opening 41B and the inlet port 41A may be formed in the same position in the side-to-side directions Y3 but spaced only in the fore-and-aft directions Y2. The opening 41B and the inlet port 41A may also be formed in the same position in the fore-and-aft directions Y2 but spaced only in the side-to-side directions Y3.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2007-088275 filed on Mar. 29, 2007, the contents of which are incorporated herein for reference.

What is claimed is:

1. A power feeding box, comprising:
an electric wire for feeding a power to a movable body to be moved in up-and-down directions; and
a housing unit contains a surplus length of the electric wire,
wherein the housing unit includes:
an inlet port which is provided on an upper side of the housing unit for introducing the electric wire into the housing unit;
an opening portion which is provided on a side face of the housing unit along in the up-and-down directions; and
a movable unit which movably fixes the electric wire extracted from the opening portion so as to move the electric wire in the up-and-down directions together with the movable unit; and
wherein the housing unit is provided in a lower half of a movable range of the movable unit.

2. The power feeding box according to claim 1, wherein a side face of the housing unit in a vicinity of the inlet port is extended toward a lower end portion of the housing unit so as to gradually leave from the inlet port.

3. The power feeding box according to claim 1, wherein the opening portion is separated from the inlet port in a first orthogonal direction perpendicular to the up-and-down directions.

4. The power feeding box according to claim 3, wherein the opening portion is separated from the inlet port in a second orthogonal direction perpendicular to the first orthogonal direction and the up-and-down directions.

5. The power feeding box according to claim 1, further comprising a pair of guide rail portions which guide a movement of the movable unit,
wherein the guide rail portions are integrally formed with the housing unit so as to interpose the opening portion therebetween.

6. The power feeding box according to claim 1, further comprising a tension cable which is provided between the movable unit and the movable body,
wherein the tension cable is shorter in a length than the electric wire arranged between the movable unit and the movable unit.
